(19) United States
(12) Patent Application Publication
(10) Pub. No.: US 2026/0159419 A1
(43) Pub. Date: Jun. 11, 2026

(54) WATER PURIFIER AND METHOD FOR OPERATING THE SAME

(71) Applicant: COWAY Co., Ltd., Gongju-si (KR)

(72) Inventors: Sang Bong JE, Seoul (KR); Min Suk CHANG, Seoul (KR); Woo Jin JOO, Seoul (KR); Won Hyuk LEE, Seoul (KR); Min Ki HONG, Seoul (KR)

(73) Assignee: COWAY Co., Ltd., Gongju-si (KR)

(21) Appl. No.: 19/397,903

(22) Filed: Nov. 22, 2025

(30) Foreign Application Priority Data
Dec. 11, 2024 (KR) 10-2024-0183891
Dec. 11, 2024 (KR) 10-2024-0183892

(51) Int. Cl. C02F 1/00

(52) U.S. Cl. CPC C02F 1/003; C02F 2201/004; C02F 2307/06

(57) ABSTRACT

In a water purifier and a method for operating the water purifier, the water purifier includes a body part, a fixing unit and a faucet part. The fixing unit is slidably connected to an upper surface of the body part. The faucet part is fixed to the upper surface of the body part by the fixing unit. The faucet part rotates from a first position to a second position when a clearance space is formed between the fixing unit and the faucet part as the fixing unit slides.

This application claims priority under 35 U.S.C. § 119 to Korean Patent Applications No. 10-2024-0183891 filed on Dec. 11, 2024, and No. 10-2024-0183892 filed on Dec. 11, 2024, the disclosures of which are incorporated by reference herein in their entireties.

### BACKGROUND OF THE INVENTION

### Technical Field

The present invention relates to a water purifier and a method for operating the water purifier, and more particularly, the present invention relates to a water purifier and a method for operating the water purifier, in which a faucet is installed at an optimal position according to a user environment by simply and accurately rotating the faucet by 90 degrees, and in which a faucet part and a built-in compatible unit are selectively coupled.

### Discussion of the Related Art

Kitchens are designed with various spatial configurations, and accordingly, the need to install a water purifier at an optimal position for a given environment is increasing. In response, technologies for variably changing a position of a water outlet of a water purifier are being developed.

For example, Korean Patent No. 10-1828260 discloses a technology in which the water outlet of a water purifier rotates within a range of 180 degrees so that the discharge position of purified water may be varied. Korean Laid-Open Patent Publication No. 10-2024-0104876 also discloses a technology in which the water outlet of a water purifier is rotated to vary the discharge position.

However, in the water purifiers developed to date, only a discharge terminal of the water outlet, rather than an entire faucet, is configured to rotate, and thus diversification of the installation of the water purifier to suit various installation environments is somewhat limited.

In addition, in order to rotate an entire faucet to diversify installation types of the water purifier, a professional technician is typically required to disassemble and reassemble the water purifier, and therefore a general user has difficulty performing such tasks independently.

Furthermore, consumer demand is increasing for water purifiers that may be compatible between a tabletop type and a built-in type depending on the installation environment, and development of such compatible water purifiers is needed.

### SUMMARY

Accordingly, the technical task of the invention is derived from these points, and exemplary embodiments of the present invention provide a water purifier and a method for operating the water purifier, capable of improving spatial utilization by allowing a faucet to be simply and accurately rotated by 90 degrees and installed at an optimal position according to a user environment, and further capable of providing a general user to easily perform the rotation operation without requiring separate tools.

In addition, exemplary embodiments of the present invention also provide a water purifier and a method for performing compatibility of the water purifier, in which a faucet part and a built-in compatible unit may be selectively coupled so that the water purifier may be compatible between a tabletop type and a built-in type, and in which even a non-professional user may easily perform the compatibility operation.

According to one aspect of the present invention, the water purifier includes a body part, a fixing unit and a faucet part. The fixing unit is slidably connected to an upper surface of the body part. The faucet part is fixed to the upper surface of the body part by the fixing unit. The faucet part rotates from a first position to a second position when a clearance space is formed between the fixing unit and the faucet part as the fixing unit slides.

In one example embodiment, the faucet part may include a water outlet for discharging purified water and a faucet block in which the water outlet is formed, and a position of the water outlet may be varied as the faucet block rotates from the first position to the second position.

In one example embodiment, the faucet block may have a rectangular block shape, and the faucet block may be rotated by 90 degrees between the first position and the second position.

In one example embodiment, the water purifier may further include a rotation unit configured to fix or release the fixing unit to or from the upper surface of the body part.

In one example embodiment, when the fixing unit is released from the body part by the rotation unit, the fixing unit may slide such that the clearance space is formed.

In one example embodiment, the rotation unit may include a rotation bar extending along an upper portion of the body part and configured to be coupled to or decoupled from the fixing unit, and a rotation part provided at one end of the rotation bar and exposed to an exterior of the body part.

In one example embodiment, the rotation part may be operated to rotate, and the rotation bar may thereby be coupled to or decoupled from the fixing unit.

In one example embodiment, the body part may include a support block provided on the upper portion, and the support block may include a guide surface configured to guide movement of the rotation bar according to rotation of the rotation part.

In one example embodiment, the fixing unit may include a fixing body including a sliding surface, and a first fixing block formed on the sliding surface and configured to be coupled to or decoupled from the rotation bar.

In one example embodiment, the first fixing block may include a first fixing frame protruding from the sliding surface and a first fixing guide provided inside the first fixing frame and including at least one first fixing groove into which the rotation bar is inserted.

In one example embodiment, the water purifier may further include a guide unit provided in the body part and configured to guide sliding of the fixing unit.

In one example embodiment, the guide unit may include a central guide portion configured to guide the fixing unit, and first and second guide portions disposed on both sides of the central guide portion and configured to guide a sliding range of the fixing unit.

In one example embodiment, each of the first and second guide portions may include a front guide groove configured to guide the first position during sliding of the fixing unit, and a rear guide groove spaced apart from the front guide groove by a predetermined distance and configured to guide the second position.

In one example embodiment, the fixing unit may be brought into contact with the faucet part at the first position, and the fixing unit may form the clearance space between the fixing unit and the faucet part at the second position.

In one example embodiment, the fixing unit may include a central protrusion guided along the central guide portion, and first and second sliding portions disposed on both sides of the central protrusion and configured to move along the first and second guide portions.

In one example embodiment, the faucet part may include a rotation connection portion formed on a rotation surface of a faucet body, a rotation plate rotatably connected to the rotation connection portion, and a fixing plate fastened to the rotation connection portion.

In one example embodiment, the rotation connection portion may include an arcuate rotation groove, and the rotation plate may include a guide protrusion guided along and moved according to the rotation groove.

In one example embodiment, the rotation plate may include an arcuate guide block protruding therefrom and first and second fixing portions respectively protruding from opposite ends of the guide block, and the fixing plate may include a fastening block moved along the guide block and first and second fastening portions disposed at opposite ends of the fastening block and configured to restrict relative movement with the rotation plate.

According to another aspect of the present invention, a method for operating the water purifier includes releasing a coupling state between a fixing unit and a body part, sliding the fixing unit on an upper surface of the body part to form a clearance space between the fixing unit and a faucet part, rotating the faucet part from a first position to a second position, sliding the fixing unit on the upper surface of the body part to bring the fixing unit into close contact with the faucet part, and coupling the fixing unit to the body part.

In one example embodiment, in the releasing of the coupling state between the fixing unit and the body part, a rotation part exposed to an exterior of the body part may be rotated in one direction to release coupling between a rotation bar connected to the rotation part and the fixing unit, and in the coupling of the fixing unit to the body part, the rotation part may be rotated in another direction to couple the rotation bar to the fixing unit.

According to still another aspect of the present invention, a water purifier includes a body part, a faucet part, and a compatible unit. The faucet part includes a water outlet from which purified water is discharged and may be coupled to an upper surface of the body part. The compatible unit includes a connection unit connected to piping through which purified water is supplied, and when the faucet part is detached from the upper surface, the compatible unit is coupled to the upper surface.

In one example embodiment, the water purifier may be used as a tabletop type when the faucet part is coupled, and may be used as a built-in type when the compatible unit is coupled.

In one example embodiment, the water outlet may discharge the purified water downward from the faucet part, and the connection unit may supply the purified water upward from the compatible unit.

In one example embodiment, the water purifier may further include a fixing unit coupled to the upper surface so as to be adjacent to the faucet part, and when the faucet part is coupled, the fixing unit may slide on the upper surface to be in close contact with the faucet part, and when coupling of the faucet part is released, the fixing unit may slide on the upper surface to form a clearance space between the fixing unit and the faucet part.

In one example embodiment, when coupling of the faucet part is released, a coupling portion provided in the clearance space may be released such that the faucet part and the fixing unit may be detached from the body part.

In one example embodiment, the water purifier may further include a rotation unit configured to fix or release the fixing unit or the compatible unit to or from the upper surface.

According to still another aspect of the present invention, a method for performing compatibility of the water purifier includes releasing a coupling state between a fixing unit and a body part, detaching a faucet part including a water outlet and the fixing unit from an upper surface of the body part, positioning a compatible unit including a connection unit connected to piping through which purified water is supplied on the upper surface, and coupling the compatible unit to the body part.

In one example embodiment, after releasing the coupling state between the fixing unit and the body part, the method may further include sliding the fixing unit on the upper surface of the body part to form a clearance space between the fixing unit and the faucet part, and releasing a coupling portion provided in the clearance space.

In one example embodiment, in the releasing of the coupling state between the fixing unit and the body part, a rotation part exposed to an exterior of the body part may be rotated in one direction to release coupling between a rotation bar connected to the rotation part and the fixing unit, and in the coupling of the compatible unit to the body part, the rotation part may be rotated in another direction to couple the rotation bar to the compatible unit.

According to exemplary embodiments of the present invention, the faucet part may be rotated to the first position and the second position, so that the position of the faucet part may be varied in consideration of an installation environment, thereby improving spatial utilization and user convenience. In this case, the faucet part maintains a fixed state by the fixing unit at each of the first position and the second position, which enables more stable fixation.

In contrast, when the fixing unit forms a predetermined clearance space through a simple sliding movement, the faucet part becomes rotatable, and a position variation of the faucet part through rotation may be implemented very easily. In particular, the sliding movement state and the fixed state of the fixing unit according to fixation or release of fixation are implemented through operation of the rotation unit, and may be easily performed by rotating a lever by a user from the exterior. Therefore, a general user who is not a professional may transition the fixing unit between a fixed state and a sliding state simply by operating the rotation part (lever), thereby improving user convenience and operability.

Specifically, the coupling and release may be implemented through coupling and release between a first fixing block formed on a lower surface of the fixing unit and a rotation bar included in the rotation unit, and thus the design and manufacture are simple, the operability is stable and easy, and the system may be manufactured with sufficient durability.

In particular, by guiding position variation of the rotation bar through a guide surface of the support block, coupling and release between the rotation bar and the first fixing block may be performed more stably.

Meanwhile, by guiding sliding of the fixing unit through the guide unit, sliding may be induced only in a predetermined sliding direction and to predetermined sliding positions, so that fixation and release of fixation between the faucet part and the fixing unit may be stably performed. That is, the sliding direction of the fixing unit may be stably guided by the central guide portion of the guide unit and the central protrusion of the fixing unit, and a sliding range of the fixing unit may be stably set through the first and second guide portions of the guide unit and the first and second sliding portions of the fixing unit.

Furthermore, the faucet part is not only guided in a rotation direction through the rotation plate and the fixing plate, but its rotation range is also restricted, so that when rotating the faucet part, the user may rotate it within a limited range in terms of rotation direction and rotation amount, thereby minimizing damage to the faucet part caused by unnecessary rotation.

In addition, since the faucet part and the compatible unit are selectively coupled to the body part, the water purifier may be selectively used as a tabletop type or a built-in type according to a user environment. Thus, suitable installation according to various use environments may enhance usability, convenience, and spatial efficiency.

In addition, since attachment and detachment of the faucet part and the compatible unit may be easily performed through release of a fastening portion, a general user who is not a professional may perform such tasks independently, thereby improving convenience for the user.

In this case, the fixing unit that fixes the position of the faucet part is slid to form a clearance space between the fixing unit and the faucet part, and the fastening portion is released while being exposed outward through the clearance space. Therefore, the fastening portion may be easily released through a simple operation of sliding movement of the fixing unit.

In particular, the state in which the fixing unit is slidable or fixes the faucet part is implemented through operation of the rotation unit, and may be easily performed by rotating the lever by the user from the exterior. Likewise, the compatible unit may also be fixed to the body part by an operation of rotating the same lever.

Therefore, a general user who is not a professional may transition the fixing unit between a fixed state and a sliding state simply by operating the rotation part (lever), and may also transition the compatible unit between a fixed state and a released state, thereby enhancing user convenience and operability.

Specifically, the coupling and release of the fixing unit and the compatible unit may be implemented through coupling and release between a fixing block formed on a lower surface of the fixing unit or the compatible unit, and a rotation bar included in the rotation unit. Thus, the design and manufacture are simple, the operability is stable and easy, and the system may be manufactured with sufficient durability.

### BRIEF DESCRIPTION OF THE DRAWINGS

FIG. 1 to FIG. 1F are perspective views illustrating a water purifier according to an example embodiment of the present invention and respective steps of a method for operating the water purifier;

FIG. 2 is a perspective view illustrating a rotation unit of FIG. 1A;

FIG. 3 is a perspective view illustrating a fixing unit of FIG. 1A;

FIG. 4A and FIG. 4B are enlarged views illustrating rotation states of the rotation unit of FIG. 1A;

FIG. 5A and FIG. 5B are side views respectively illustrating coupling states between the rotation unit and the fixing unit in FIG. 4A and FIG. 4B;

FIG. 6 is a perspective view illustrating a guide unit formed on a third side surface of a body part of FIG. 1A;

FIG. 7A and FIG. 7B are perspective views illustrating a fixing unit sliding along the guide unit of FIG. 6;

FIG. 8 is an exploded perspective view illustrating a faucet part of FIG. 1A;

FIG. 9A is a plan view illustrating a rotation surface of a faucet body of FIG. 8, FIG. 9B is a plan view illustrating a rotation plate of FIG. 8, FIG. 9C is a bottom view illustrating the rotation plate of FIG. 8, and FIG. 9D is a plan view illustrating a fixing plate of FIG. 8;

FIG. 10A to FIG. 10C are perspective views illustrating a compatibility method of the water purifier of FIG. 1A; and

FIG. 11 is a perspective view illustrating a compatible unit of FIG. 10B.

### DETAILED DESCRIPTION OF THE INVENTION

The present invention may be modified in various ways and may take different forms, therefore, specific embodiments will be described in detail in the specification. However, the disclosure is not intended to limit the invention to the particular forms described, and it should be understood to include all modifications, equivalents, and alternatives that fall within the spirit and scope of the invention. In the drawings, similar reference numerals designate corresponding elements, and terms such as “first,” “second,” etc. are merely used to distinguish one element from another, and are not intended to limit the scope of the invention.

The terminology used in the present application is for the purpose of describing particular embodiments only, and is not intended to limit the invention. Unless the context clearly indicates otherwise, the singular forms include the plural. As used herein, the terms “include” and “consist of” indicate the presence of features, numerals, steps, operations, elements, parts, or combinations thereof described in the specification, but do not preclude the possibility of the presence or addition of one or more other features, numerals, steps, operations, elements, parts, or combinations thereof.

Hereinafter, the present invention will be explained in detail with reference to the accompanying drawings.

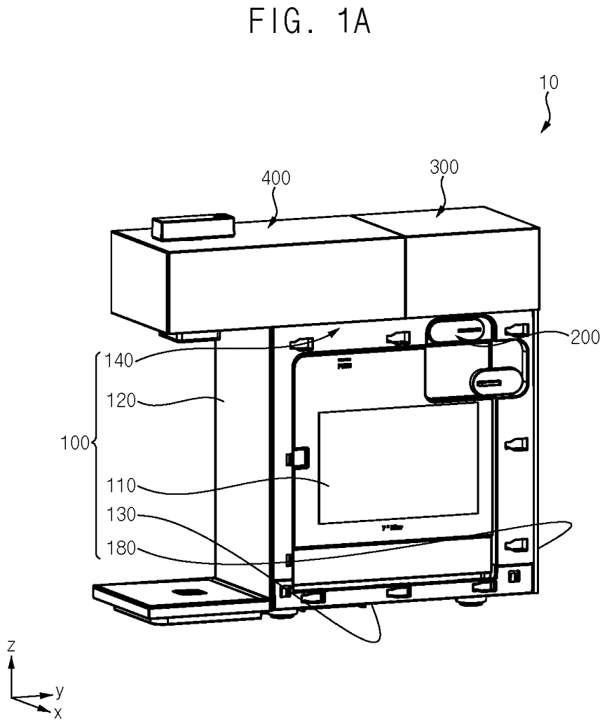

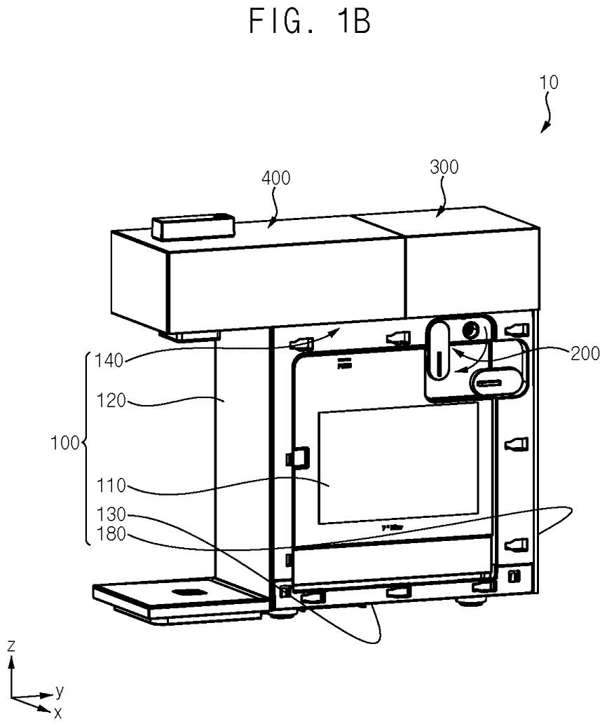

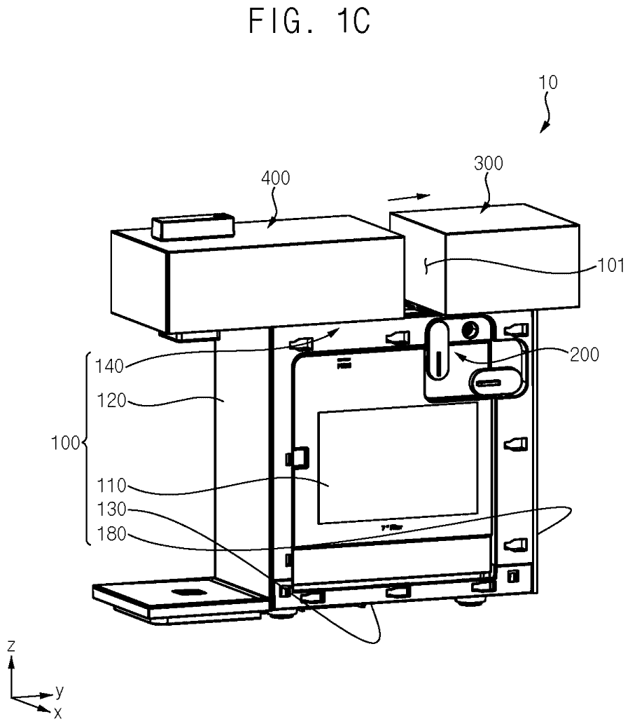

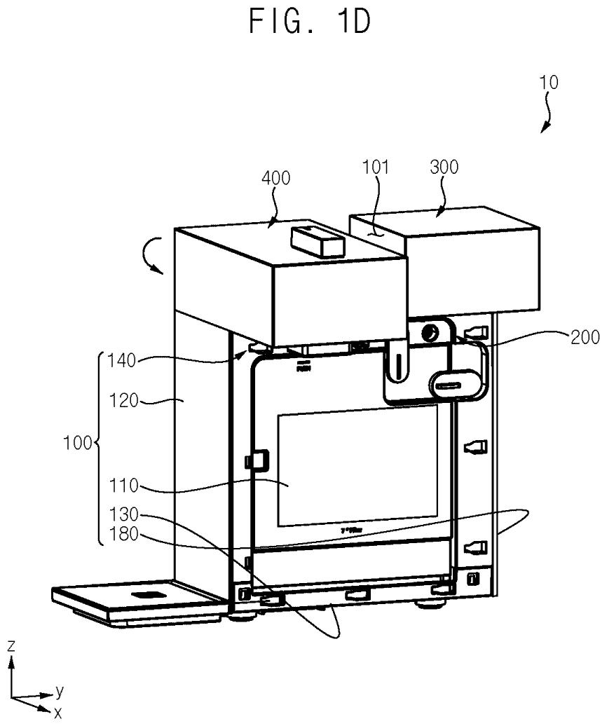

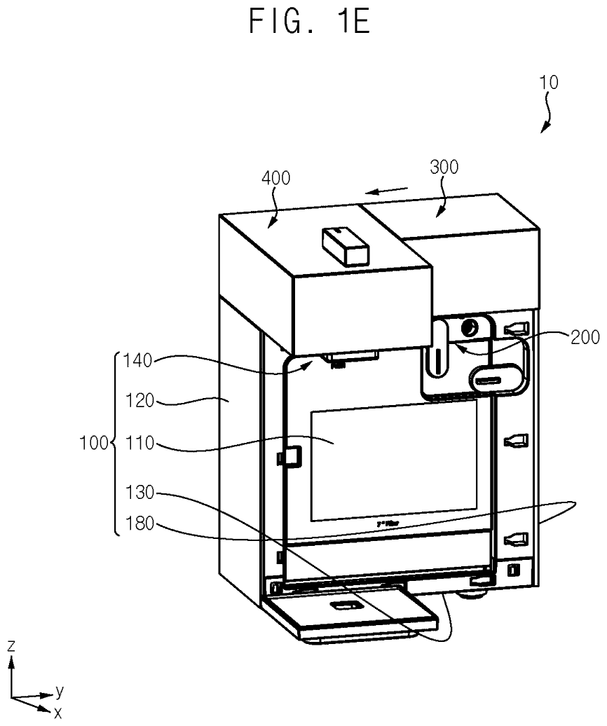

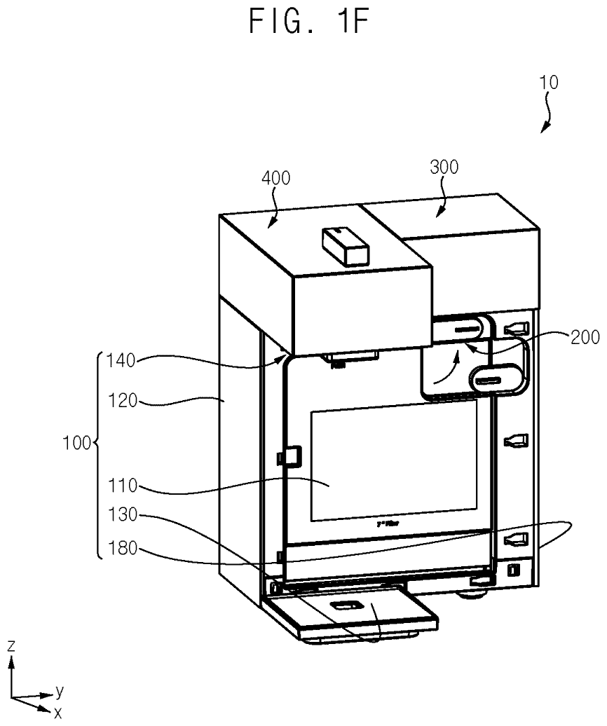

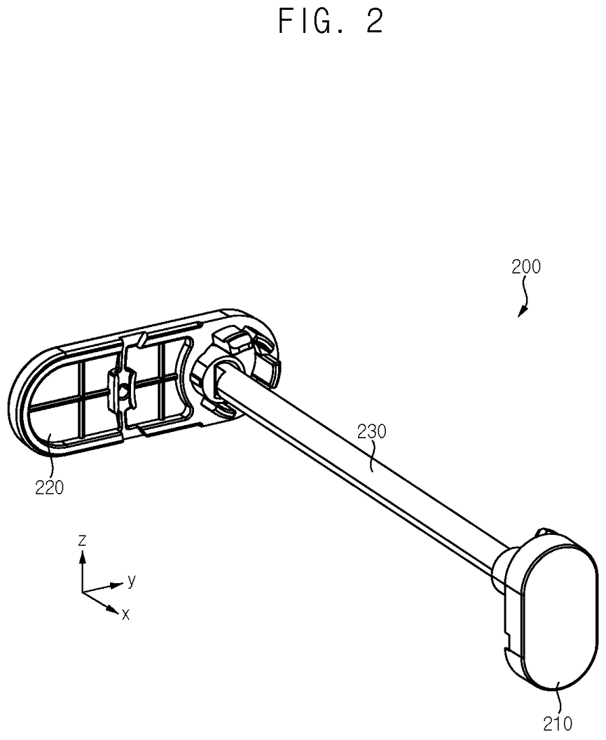

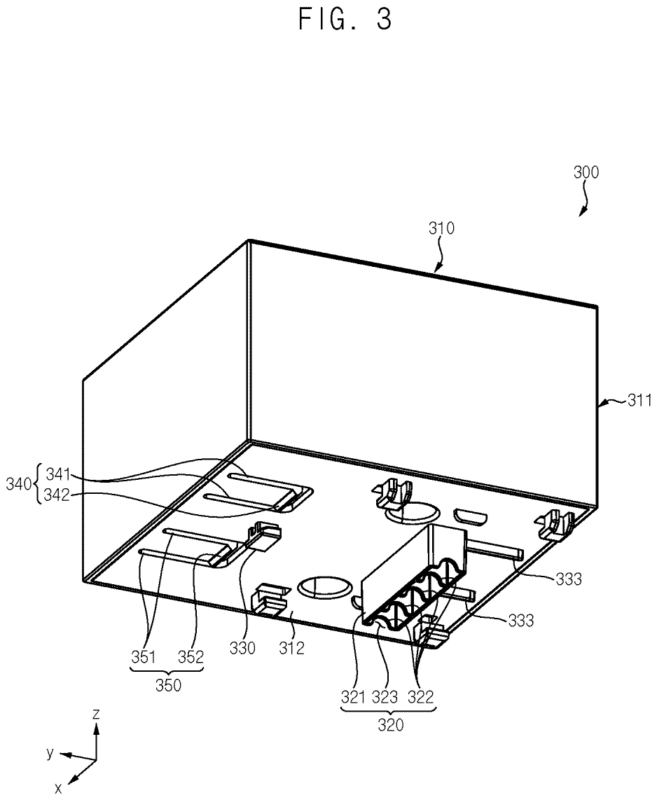

FIG. 1 to FIG. 1F are perspective views illustrating a water purifier according to an example embodiment of the present invention and respective steps of a method for operating the water purifier. FIG. 2 is a perspective view illustrating a rotation unit of FIG. 1A. FIG. 3 is a perspective view illustrating a fixing unit of FIG. 1A.

First, with reference to FIG. 1A, FIG. 2, and FIG. 3, the water purifier 10 according to the present example embodiment is described. That is, as shown, the water purifier 10 according to the present example embodiment includes a body part 100, a rotation unit 200, a fixing unit 300, and a faucet part 400.

The body part 100 forms a body of the water purifier 10, and includes a first surface 110, a second surface 120, a third surface 180, a bottom surface 130, and an upper surface 140, and may have an overall rectangular block shape. However, a shape or structure of the body part 100 is not necessarily limited thereto. Meanwhile, components required for operation of the water purifier 10 are provided inside the body part 100, and a detailed description thereof will be omitted.

As shown, the first surface 110 is a surface facing a first direction X, and the second surface 120 is a surface that is perpendicularly connected to the first surface 110, that is, a surface facing a second direction Y perpendicular to the first direction X. In addition, the third surface 180 is a surface facing the second surface 120 in the second direction Y, and the bottom surface 130 and the upper surface 140 correspond to surfaces facing each other along a third direction Z. Here, the third direction Z is defined as a direction perpendicular to both the first and second directions X and Y.

Referring to FIG. 2, the rotation unit 200 includes a rotation part 210, an insertion part 220, and a rotation bar 230, and is coupled to an upper portion of the body part 100 as in FIG. 1A.

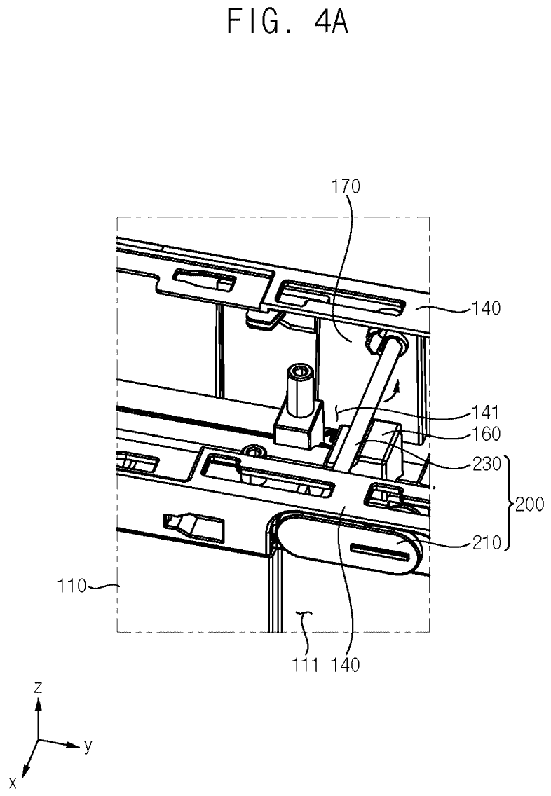

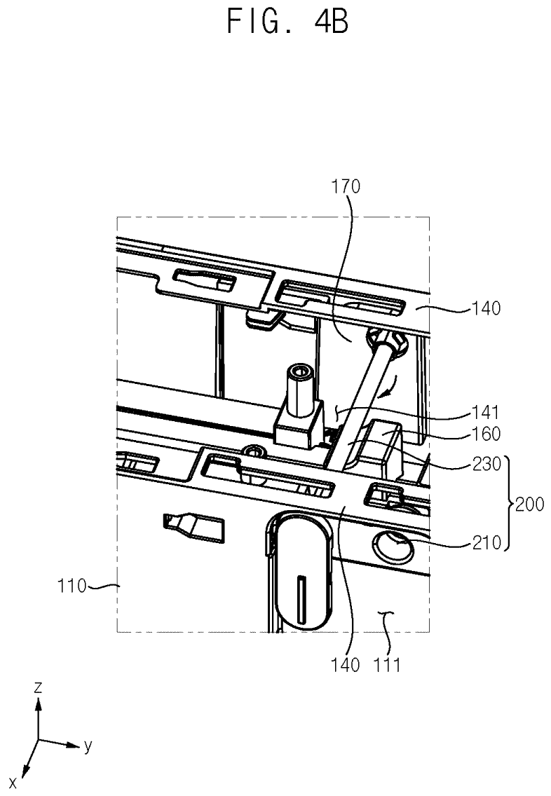

The rotation part 210 is coupled to the body part 100 so as to be exposed to an outside of the first surface 110 of the body part 100, and corresponds to a lever directly operated by a user. The insertion part 220 is disposed to face the rotation part 210 and may be located inside a surface facing the first surface 110. In this case, the rotation bar 230 extends between the rotation part 210 and the insertion part 220 and extends while passing through an upper space 141 (see FIG. 4A) of the body part 100.

A more detailed description of the rotation unit 200 will be given later.

The fixing unit 300 is coupled to one side of the upper surface 140 of the body part 100 and, as shown, includes a fixing body 310 having an overall rectangular block shape. The fixing unit 300 does not need to include separate components inside, and corresponds to a structure that fixes a position of the faucet part 400 or is slid so as to form a predetermined clearance space 101 for rotation of the faucet part 400.

As shown in FIG. 3, on a sliding surface 312, which is a lower surface of the fixing body 310 of the fixing unit 300, a first fixing block 320 is formed.

The first fixing block 320 includes a first fixing frame 321 protruding from the sliding surface 312 and a first fixing guide 322 provided inside the first fixing frame 321, at least one of which is arranged in parallel with one another in the first direction X.

The first fixing frame 321 may have an overall rectangular block shape extending in the first direction X and is open in a downward direction. The first fixing guide 322 is provided in an internal space formed by the first fixing frame 321, and at least one of the first fixing guide 322 is arranged along the first direction X, and each has the same shape.

In this case, a predetermined first fixing groove 323 is formed on a lower side of the first fixing guide 322, and as shown, the first fixing groove 323 may have a semicircular shape. Thus, as will be described later, the rotation bar 230 may be inserted into and positioned in the first fixing groove 323.

The faucet part 400 is coupled to the other side of the upper surface 140 of the body part 100 and is positioned adjacent to the fixing unit 300. That is, as shown in FIG. 1A, the faucet part 400 and the fixing unit 300 are disposed on the upper surface 140 so as to be in contact with each other, and through this contact state, a position of the faucet part 400 may be stably fixed by the fixing unit 300.

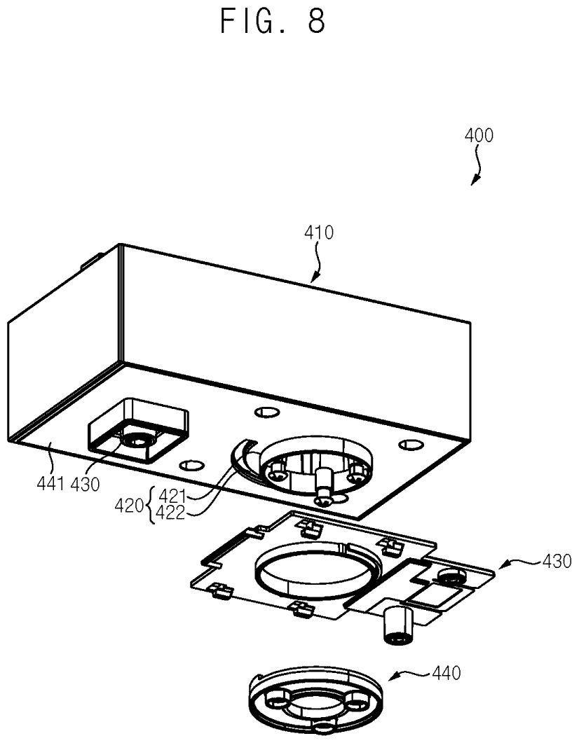

Meanwhile, the faucet part 400 includes a water outlet 430 (see FIG. 8), and piping for discharging purified water or the like is provided inside the faucet part 400. Although not shown, a display unit for providing various states or information of the water purifier may be formed. In this case, as shown, the water outlet 430 is exposed toward a lower direction (a negative third direction −Z) and discharges purified water downward to be supplied to a user.

In addition, the faucet part 400 may also include a faucet body 410 having an overall rectangular block shape. In this case, FIG. 1A illustrates an example in which a block size of the faucet part 400 is larger than a block size of the fixing unit 300, but is not limited thereto, and it is sufficient that the position of the faucet part 400 may be fixed through the fixing unit 300.

Based on the basic structure of the water purifier 10 as described above, a method for operating the water purifier 10, that is, a rotation operation of the faucet part 400 in the water purifier 10, will be described with reference to FIG. 1A to FIG. 1F, as follows.

First, referring to FIG. 1A, at a first position (a position of the faucet part in FIG. 1A is referred to as the first position), the faucet part 400 is brought into close contact with the fixing unit 300 and its position is fixed. At this time, as shown, the faucet part 400 is in a state in which the water outlet 430 faces the second surface 120. That is, when the faucet part 400 is a rectangular block that extends relatively long in one direction, a direction in which the faucet part 400 extends relatively long is positioned to be parallel to the second direction Y.

Although not shown, at the first position, the rotation bar 230 of the rotation unit 200 is engaged on the first fixing groove 323, so that the fixing unit 300 is in a state in which its position is stably fixed and performs stable position fixation for the faucet part 400.

In the first position, the user may extract purified water and use the same through the water outlet 430 on the side of the second surface 120.

Thereafter, in order to change a discharge direction of the purified water, a direction change operation of the faucet part 400 of FIG. 1B to FIG. 1F is performed.

First, referring to FIG. 1B, the rotation part 210, which is exposed outward on the first surface 110 of the body part 100, is turned in a direction indicated by an arrow. That is, the rotation part 210 may be rotated by, for example, 90 degrees in a clockwise direction from the position at the first position.

By such a rotation operation of the rotation part 210, the rotation bar 230, which has been engaged on the first fixing groove 323, moves outward from the first fixing groove 323, and thus a fixed state of the fixing unit 300 is released.

Thereafter, referring to FIG. 1C, as the fixed state of the fixing unit 300 is released, the fixing unit 300 is slid in a positive second direction +Y as indicated by an arrow.

In this case, the fixing unit 300 is guided in terms of a sliding direction and a sliding range through a guide unit 500, which will be described later, and is slid in the positive second direction +Y. Detailed explanation regarding guidance of the sliding direction and sliding range of the fixing unit 300 by the guide unit 500 will be described later.

Accordingly, a predetermined clearance space 101 is generated between a fixing surface 311 of the fixing unit 300 and the faucet part 400. At this time, a size of the clearance space 101 only needs to be such that the faucet part 400, which will be described later, may be rotated, and in consideration thereof, the sliding range of the fixing unit 300 is also limited.

Thereafter, referring to FIG. 1D, in a state in which the clearance space 101 is generated, the faucet part 400 is rotated with the third direction Z as a rotation central axis to change an extending direction of the faucet part 400. In this case, for example, the faucet part 400 may be rotated by 90 degrees, and more specific rotation guidance of the faucet part 400 will be described later.

Accordingly, the water outlet 430 of the faucet part 400 is positioned to face the first surface 110.

Thereafter, referring to FIG. 1E, in a state in which the faucet part 400 has been rotated, the fixing unit 300 is slid in a direction opposite to the moving direction in FIG. 1C, that is, in a negative second direction −Y as indicated by an arrow. Thus, the fixing surface 311 of the fixing unit 300 is again brought into close contact with the faucet part 400.

Thereafter, referring to FIG. 1F, in order to fix a position of the fixing unit 300 that has been brought into close contact with the faucet part 400, the rotation part 210 is turned back to the position of FIG. 1A. That is, the rotation part 210 is rotated again, for example, in a counterclockwise direction as indicated by an arrow. Accordingly, although not shown, a position of the rotation bar 230 connected to the rotation part 210 is also varied and is engaged on the first fixing groove 323 of the first fixing guide 322.

Thus, as in FIG. 1F, the position of the fixing unit 300 is stably fixed in a state of being in close contact with the faucet part 400, and the position of the faucet part 400 is also

### Stably Fixed.

When a position of the faucet part 400 in FIG. 1F is referred to as a second position, in the second position, the faucet part 400 may discharge purified water or the like toward the first surface 110. That is, as described above, when the faucet part 400 is a rectangular block that extends relatively long in one direction, a direction in which the faucet part 400 extends relatively long is positioned to be parallel to the first direction X.

Furthermore, in order to change the direction of the faucet part 400 from the second position to the first position, it is sufficient to perform the operations in reverse order from the above description, that is, from the step of FIG. 1F to the step of FIG. 1A.

As described above, the direction of the faucet part 400 may be changed by 90 degrees from the first position to the second position, and at each position, a stable fixed state may be maintained through fixation by the fixing unit 300. Furthermore, the direction change of the faucet part 400 may be performed through an operation of turning the rotation part 210 by 90 degrees and an operation of sliding the fixing unit 300 in the second direction Y, and therefore even a general user who is not a professional may easily perform the operations.

Accordingly, whenever necessary, the user may improve convenience in installation and use by changing the direction of the faucet part 400.

Hereinafter, coupling and release of coupling between the rotation bar 230 and the first fixing guide 322 will be described in more detail.

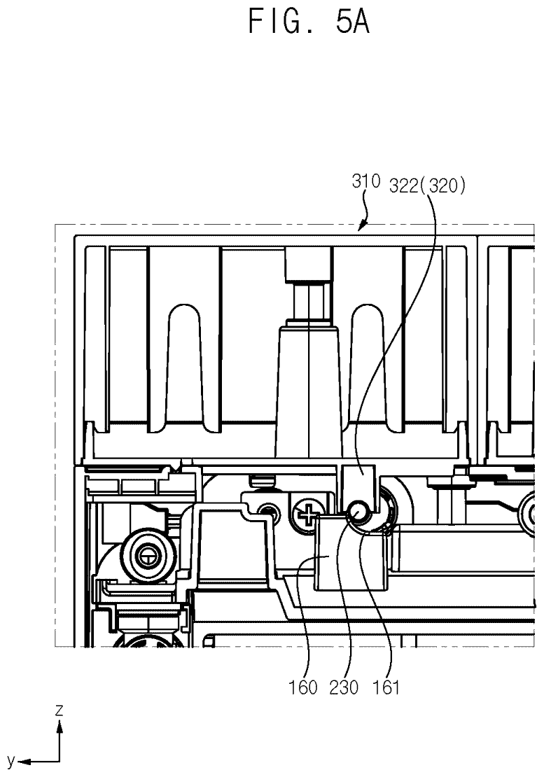

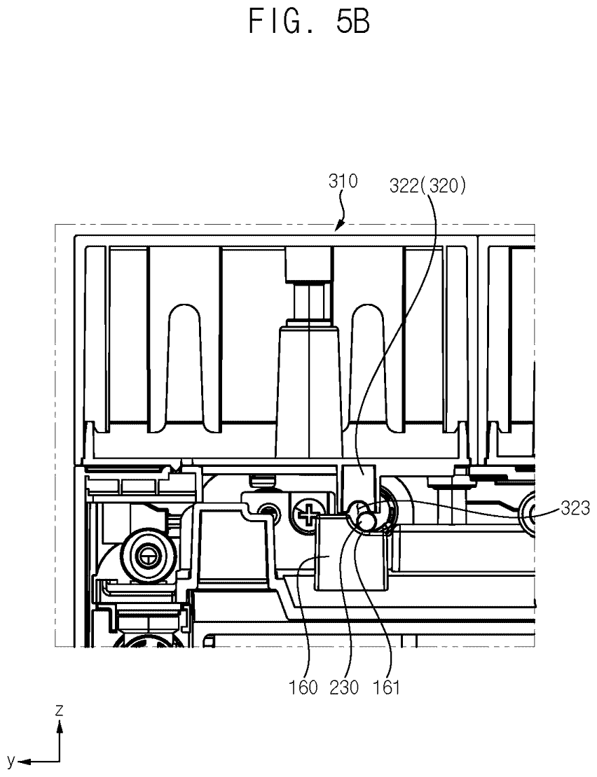

FIG. 4A and FIG. 4B are enlarged views illustrating rotation states of the rotation unit of FIG. 1A. FIG. 5A and FIG. 5B are side views respectively illustrating coupling states between the rotation unit and the fixing unit in FIG. 4A and FIG. 4B.

With reference first to FIG. 4A and FIG. 4B, in the rotation unit 200, the rotation part 210 is positioned so as to be exposed to the outside of the first surface 110, and in this case, the rotation part 210 is positioned in a predetermined accommodating recess 111 formed on the outside of the first surface 110. Accordingly, a user may place a finger in the accommodating recess 111, which is recessed by a predetermined depth from the first surface 110, thereby performing a rotation operation on the rotation part 210 more easily.

In addition, in the rotation unit 200, the insertion part 220 is positioned inside a predetermined insertion space 170 formed on a surface opposite to the side on which the accommodating recess 111 is formed. That is, only the rotation part 210 needs to be exposed outward in the rotation unit 200, and the insertion part 220, which is rotated according to a rotation operation of the rotation part 210, does not need to be exposed outward and may be positioned inside the insertion space 170 so that it is sufficient for the insertion part 220 to perform rotation according to a rotation operation of the rotation part 210. In this case, although not shown in detail, the insertion space 170 may include an appropriate space and necessary guides so that the insertion part 220 may rotate by 90 degrees and its position may be varied.

As described above, with the rotation part 210 and the insertion part 220 positioned, the rotation bar 230 extends in the first direction X in the upper space 141. In this case, the rotation bar 230 only needs to extend at a position close to the upper surface 140 and may be extended at a position located inward by a predetermined depth from the upper surface 140 in consideration of a position where the first fixing block 320 is located.

As shown in FIG. 4A and FIG. 4B, the rotation bar 230 extending in the upper space 141 has its position varied as the rotation part 210 rotates by 90 degrees from the first position to the second position. More specifically, it may be seen that the rotation bar 230 is positioned lower in FIG. 4B than in FIG. 4A.

In this case, a separate support block 160 is provided in the upper space 141, and the support block 160 is positioned so as to support a central portion of the rotation bar 230. The support block 160 has an overall block shape, and a guide surface 161 for supporting the rotation bar 230 is formed to have a predetermined curved surface shape.

Thus, in FIG. 4A, the rotation bar 230, which is relatively in contact with an upper side of the guide surface 161, is guided along the guide surface 161 and moves downward in accordance with rotation of the rotation part 210, and in FIG. 4B, is positioned in a state of being relatively in contact with a lower side of the guide surface 161.

That is, when observed along the first direction X, the guide surface 161 may have a quarter-arc shape, and the rotation bar 230 has its position varied from an upper side to a lower side along the guide surface 161. Accordingly, the rotation bar 230 is positioned at a relatively high position in FIG. 4A and at a relatively low position in FIG. 4B.

A coupling state between the rotation bar 230 and the first fixing block 320 according to the position of the rotation bar 230 will now be described.

Referring to FIG. 5A, in the first position or the second position (the position of FIG. 1A or FIG. 1F), the rotation bar 230 is positioned on an upper side of the guide surface 161, and the rotation bar 230 is inserted into the fixing groove 323 of the first fixing guide 322. Therefore, in the position of FIG. 5A, the fixing unit 300 is in a state fixed by the rotation unit 200, and movement of the fixing unit 300 is restricted along the second direction Y.

Alternatively, referring to FIG. 5B, as the rotation part 210 is rotated, the rotation bar 230 moves along the guide surface 161 and is positioned on a lower side of the guide surface 161. Accordingly, the rotation bar 230 is positioned outward from the fixing groove 323 of the first fixing guide 322. Thus, in the position of FIG. 5B, the fixing unit 300 is in a state in which fixation by the rotation unit 200 is released, and the fixing unit 300 becomes movable along the second direction Y.

Accordingly, as described earlier with reference to FIG. 1C and FIG. 1E, the fixing unit 300 may be slid along the second direction Y.

Hereinafter, a description will be given regarding guidance of a sliding direction and a sliding range when the fixing unit 300 is slid. That is, when the fixing unit 300 is slid along the second direction Y as in FIG. 1C and FIG. 1E, it may be difficult for a general user who is not a professional to determine how far the fixing unit 300 should be slid. Accordingly, as described later, by guiding a sliding direction and a sliding range of the fixing unit 300, user convenience may be improved.

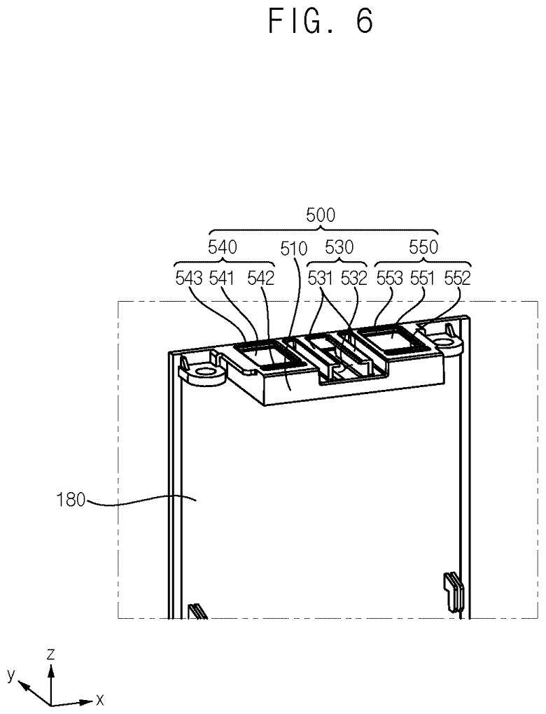

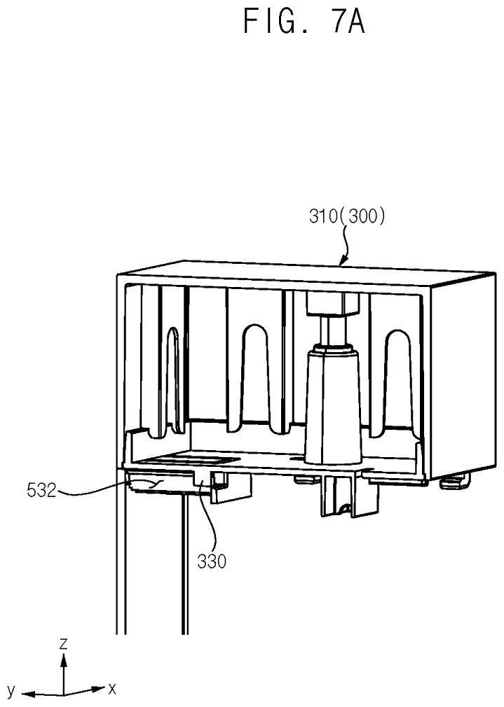

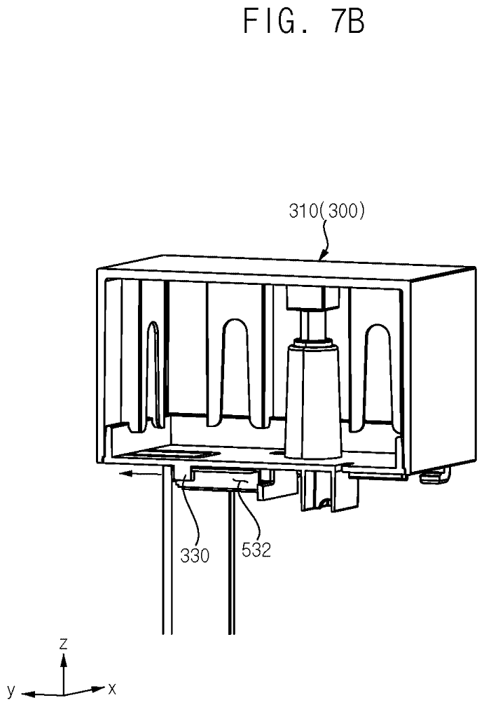

FIG. 6 is a perspective view illustrating a guide unit formed on a third side surface of a body part of FIG. 1A. FIG. 7A and FIG. 7B are perspective views illustrating a fixing unit sliding along the guide unit of FIG. 6.

First, referring to FIG. 6, a guide unit 500 is additionally provided on a third surface 180 of the body part 100. In this case, the guide unit 500 guides sliding of the fixing unit 300 and thus may be provided on an upper side of the third surface 180 on which the fixing unit 300 is positioned.

That is, as shown, the guide unit 500 extends and is formed in a direction parallel to the upper surface 140 from the upper side of the third surface 180.

More specifically, the guide unit 500 includes a guide frame 510, a central guide portion 530, and first and second guide portions 540 and 550.

The guide frame 510 is a predetermined frame extending in a direction parallel to the upper surface 140 from the upper side of the third surface 180, and the central guide portion 530 and the first and second guide portions 540 and 550 are formed on an upper surface of the guide frame 510. In this case, a length of the guide frame 510 in the second direction Y may be appropriately formed in consideration of lengths of the central guide portion 530 and the first and second guide portions 540 and 550.

The central guide portion 530 extends in the second direction Y along a central region of the guide frame 510 and includes a pair of spaced-apart central guides 531 and a central guide groove 532 formed inside the central guides 531.

The first guide portion 540 extends in the second direction Y on one side of the central guide portion 530. The first guide portion 540 includes a groove-shaped first guide groove 541 extending by a predetermined length and first front and rear guide grooves 542 and 543 respectively formed at both ends of the first guide groove 541 in the second direction Y.

The second guide portion 550 extends in the second direction Y on the other side of the central guide portion 530 and has the same shape as the first guide portion 540. That is, the second guide portion 550 includes a groove-shaped second guide groove 551 extending by a predetermined length and second front and rear guide grooves 552 and 553 respectively formed at both ends of the second guide groove 551 in the second direction Y.

Meanwhile, the guide unit 500 is coupled to the sliding surface 312, which is the lower surface of the fixing unit 300 described above. With reference to FIG. 3, a configuration for sliding formed in the fixing unit 300 will be described.

Referring again to FIG. 3, the fixing unit 300 includes a central protrusion 330 and first and second sliding portions 340 and 350 formed on the sliding surface 312, which is the lower surface of the fixing body 310.

The central protrusion 330 is formed on a rear side of the fixing unit 300 in the sliding surface 312 along the second direction Y. That is, the central protrusion 330 is coupled to the central guide portion 530, and since the guide unit 500 is formed on the third surface 180 side, the central protrusion 330 also needs to be formed at a position close to the third surface 180.

The central protrusion 330 may have a so-called hook shape that protrudes downward by a predetermined length from the sliding surface 312. Accordingly, the central protrusion 330 is positioned to be inserted into the central guide groove 532 described above. In addition, both side surfaces of the central protrusion 330 are guided by the central guides 531. Thus, as shown in FIG. 7A and FIG. 7B, the central protrusion 330 has its moving direction guided by the central guides 531 and slides in the second direction Y along the central guide groove 532.

As described above, when the fixing unit 300 is slid on the upper surface 140, a sliding direction may be stably guided to follow the second direction Y by the guide unit 500.

Meanwhile, the first sliding portion 340 is formed on one side of the central protrusion 330 and is coupled to the first guide portion 540 to limit a sliding range of the fixing unit 300.

That is, the first sliding portion 340 includes a first line part 341 and a first protrusion 342 and may have an overall predetermined elasticity. In other words, the first protrusion 342 may have elasticity within a predetermined range in an up-and-down direction so that its position may be varied.

Thus, in a state in which the first protrusion 342 is inserted into the first guide groove 541, the first protrusion 342 slides along the first guide groove 541 and may be fixed in a state of being inserted into the first front guide groove 542 or the first rear guide groove 543. Of course, such fixing force is not relatively large and is only required to be sufficient for a user to visually or tactually recognize a stroke range of sliding of the fixing unit 300 from the outside.

The same applies to the second sliding portion 350. That is, the second sliding portion 350 is formed on the other side of the central protrusion 330 and includes a second line part 351 and a second protrusion 352 and may have an overall predetermined elasticity. In other words, the second protrusion 352 may have elasticity within a predetermined range in an up-and-down direction so that its position may be varied.

Thus, in a state in which the second protrusion 352 is inserted into the second guide groove 551, the second protrusion 352 slides along the second guide groove 551 and may be fixed in a state of being inserted into the second front guide groove 552 or the second rear guide groove 553.

As described above, when the first and second protrusions are slid along the first and second guide grooves 541 and 551 and then are inserted into and fixed in the first and second front guide grooves 542 and 552, respectively, the fixing unit 300 is brought into close contact with the faucet part 400 and fixes the faucet part 400, as shown in FIG. 7A.

Alternatively, when the first and second protrusions are slid along the first and second guide grooves 541 and 551 and then are inserted into and fixed in the first and second rear guide grooves 543 and 553, respectively, the fixing unit 300 is in a state in which it has moved to a maximum position in the second direction Y, and a predetermined clearance space 101 is formed between the fixing unit 300 and the faucet part 400, as shown in FIG. 7B.

Accordingly, on the basis of a state in which the first and second protrusions are fixed in the first and second front guide grooves 542 and 552 or in the first and second rear guide grooves 543 and 553, a user may recognize a sliding movement range of the fixing unit 300 in the second direction Y.

Hereinafter, a state in which rotation is performed when a position of the faucet part 400 is changed between the first position and the second position will be described in detail.

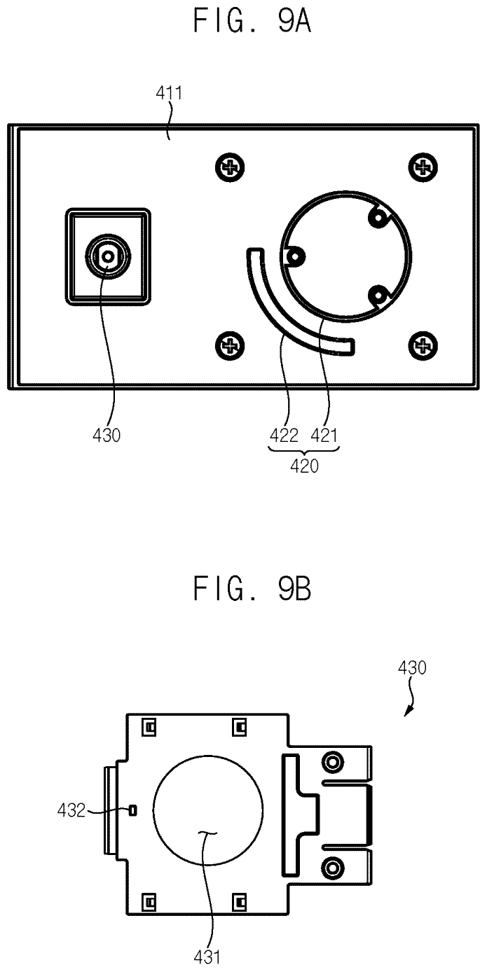

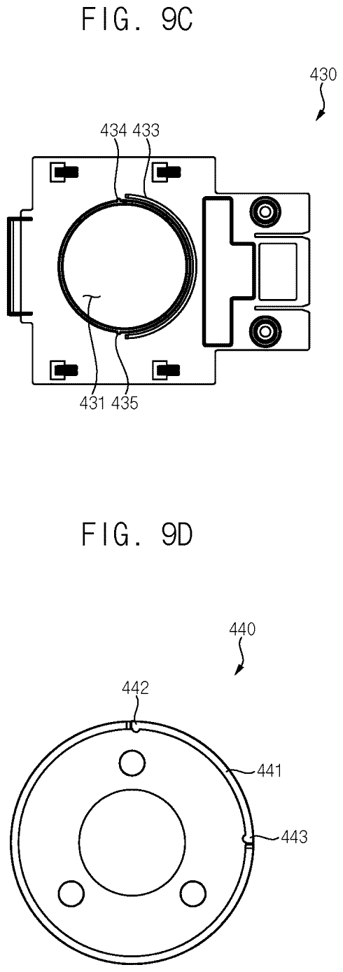

FIG. 8 is an exploded perspective view illustrating a faucet part of FIG. 1A. FIG. 9A is a plan view illustrating a rotation surface of a faucet body of FIG. 8, FIG. 9B is a plan view illustrating a rotation plate of FIG. 8, FIG. 9C is a bottom view illustrating the rotation plate of FIG. 8, and FIG. 9D is a plan view illustrating a fixing plate of FIG. 8.

With reference to FIG. 8, the faucet part 400 includes a rotation connection portion 420 formed on the faucet body 410, a rotation plate 430, and a fixing plate 440. In this case, the rotation plate 430 is fixed to the upper surface 140 of the body part 100, and the rotation connection portion 420 and the fixing plate 440 are fixed to each other.

Accordingly, in a state in which the rotation plate 430 is fixed, the faucet body 410 and the fixing plate 440 are integrally coupled to each other and rotate with respect to the rotation plate 430 so that their posture may be varied within a 90-degree range, as described above.

More specifically, referring to FIG. 8 and FIG. 9A, the rotation connection portion 420 is formed on a rotation surface 411 that contacts the rotation plate 430. The rotation connection portion 420 includes a connection frame 421 and a rotation groove portion 422.

As shown, the connection frame 421 protrudes from the rotation surface 411 to have a circular frame shape, and the rotation groove portion 422 is a groove formed in an arcuate shape along the circumference of the connection frame 421 so as to be adjacent to the connection frame 421. In this case, as illustrated, the rotation groove portion 422 follows the circumference of the connection frame 421 but is formed only along, for example, a quarter-arc. Thus, the faucet part 400 may rotate within a 90-degree range, corresponding to the quarter-arc.

Referring to FIG. 8, FIG. 9B, and FIG. 9C, the rotation plate 430 has a predetermined plate shape and is positioned to contact the rotation surface 411. In this case, although not shown, the rotation plate 430 is fixed to the body part 100 as described above, and its position does not vary.

The upper surface of the rotation plate 430 contacts the rotation connection portion 420 formed on the rotation surface 411 (see FIG. 9B), and the lower surface of the rotation plate 430 contacts the fixing plate 440, which is coupled to the rotation connection portion 420 (see FIG. 9C).

First, on the upper surface of the rotation plate 430, as shown in FIG. 9B, an opening 431 is formed at a position aligned with the connection frame 421, and a guide protrusion 432 is formed adjacent to the opening 431. The guide protrusion 432 is positioned to be inserted into the rotation groove portion 422.

Accordingly, the faucet body 410 is guided by the guide protrusion 432 and the rotation groove portion 422 so that rotation is enabled within the 90-degree arc range in which the rotation groove portion 422 is formed.

Meanwhile, on the lower surface of the rotation plate 430, as shown in FIG. 9C, a guide block 433 and a pair of first and second fixing portions 434 and 435 are formed adjacent to the opening 431. The guide block 433 extends, for example, along a 180-degree arc following the arc of the opening 431, and the first and second fixing portions 434 and 435 are formed so as to protrude at positions spaced apart from both ends of the guide block 433.

Referring to FIG. 8, FIG. 9C, and FIG. 9D, the fixing plate 440 rotates relative to the rotation plate 430 in a state in which the fixing plate 440 is fixed to the faucet body 410.

As shown in FIG. 9D, the fixing plate 440 includes a fastening block 441 and first and second fastening portions 442 and 443 protruding from a surface facing the rotation plate 430. In this case, the fastening block 441 and the first and second fastening portions 442 and 443 limit a rotation range of the faucet body 410 and the rotation plate 430.

That is, the fastening block 441 has the shape of a guide frame protruding along a quarter-arc, that is, across a 90-degree range, and is coupled to the guide block 433. Accordingly, when the fixing plate 440 rotates relative to the rotation plate 430, a rotation direction is guided by the guide block 433 and the fastening block 441.

In addition, the first and second fastening portions 442 and 443 protrude from both ends of the fastening block 441 toward a central region and function as stoppers. That is, the first and second fastening portions 442 and 443 limit relative rotation of the fixing plate 440 with respect to the rotation plate 430 when either the first or second fastening portion contacts one of the first or second fixing portions 434 and 435.

For example, when the fastening block 441 rotates in one direction and the first fastening portion 442 contacts the first fixing portion 434, further rotation in that direction may be restricted. Alternatively, when the fastening block 441 rotates in the opposite direction and the second fastening portion 443 contacts the second fixing portion 435, further rotation in that direction is restricted.

In this case, the guide block 433 is extended along a half-arc (180 degrees), and the fastening block 441 is extended along a quarter-arc (90 degrees). Thus, rotation in a specific direction may be restricted when one of the first and second fastening portions 442 and 443 contacts one of the first and second fixing portions 434 and 435. Of course, depending on design, the guide block 433 may also be formed along a quarter-arc such that each of the first and second fastening portions 442 and 443 is restricted in both rotational directions by the first and second fixing portions 434 and 435.

Through the above limitation of a rotation range, a user may recognize a degree of rotation, that is, the rotation range, of the faucet body 410 without applying unnecessary external force to forcibly rotate the faucet body 410. Accordingly, damage to the faucet part 400 during the rotation process may be minimized.

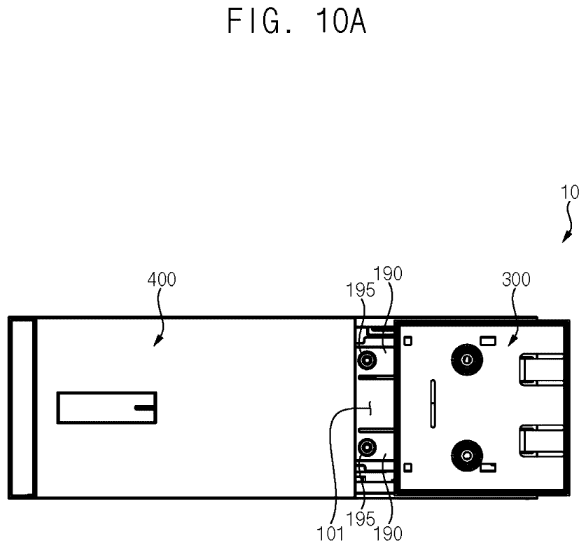

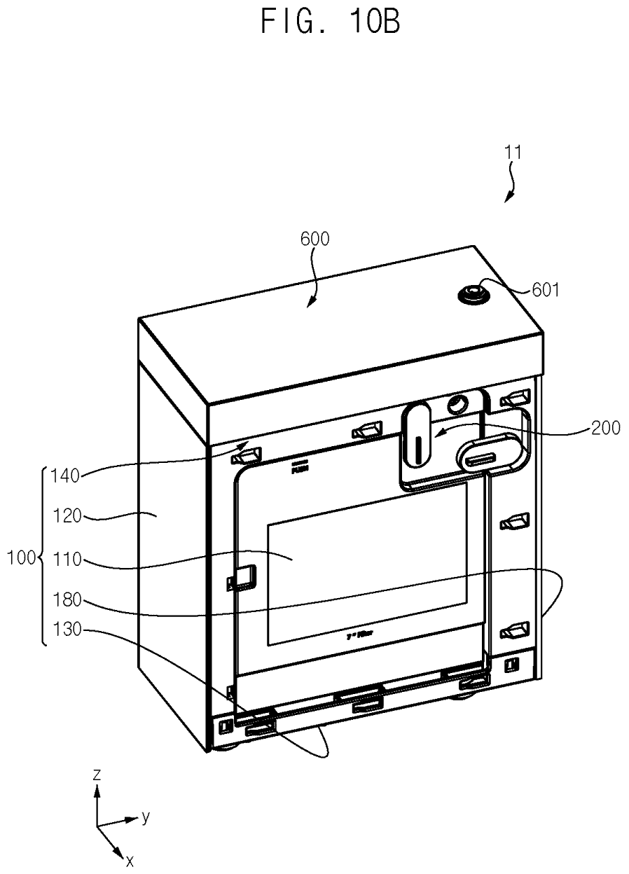

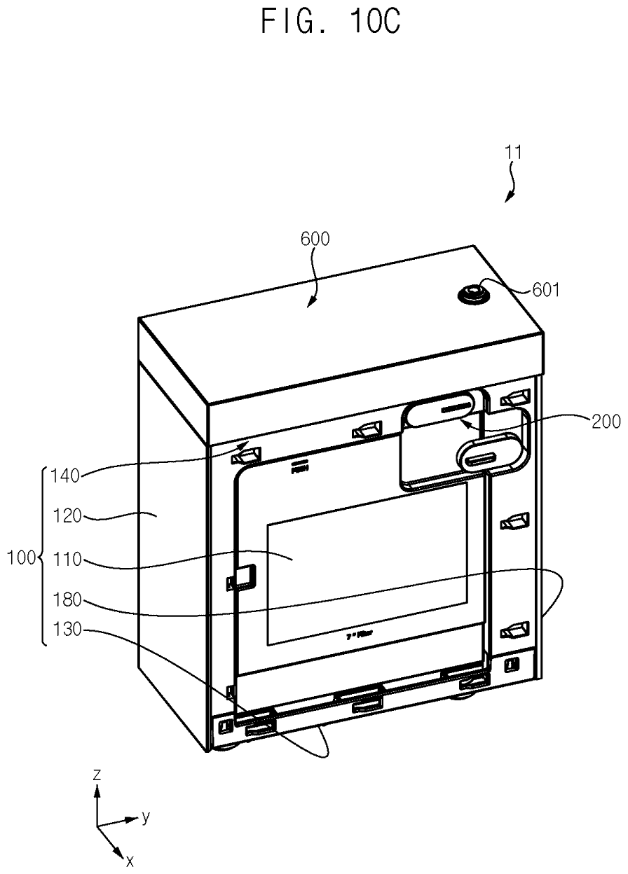

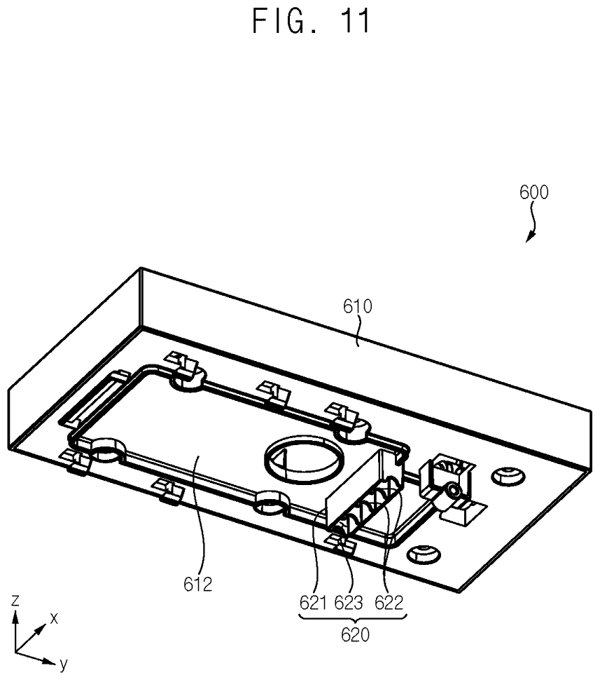

FIG. 10A to FIG. 10C are perspective views illustrating a compatibility method of the water purifier of FIG. 1A. FIG. 11 is a perspective view illustrating a compatible unit of FIG. 10B.

Referring first to FIG. 1A, in the water purifier 10 described above, the faucet part 400 may be fixed on the upper surface 140 of the body part 100 together with the fixing unit 300, and in such a fixed state, the water purifier 10 may be used as a so-called tabletop water purifier. That is, the water purifier 10 illustrated in FIG. 1A may be installed on an upper surface of a sink or other various tables and used to provide purified water to a user.

In this case, as will be described later, the faucet part 400 and the fixing unit 300 may be integrally removed from the upper surface 140. When the faucet part 400 and the fixing unit 300 are integrally removed from the upper surface 140, a compatible unit 600 may be mounted onto the upper surface 140 as shown in FIG. 10B.

That is, the compatible unit 600 may have an overall rectangular block shape and may have a size corresponding to an entire area of the upper surface 140. Accordingly, the compatible unit 600 may be mounted in the same position from which the faucet part 400 and the fixing unit 300 are removed.

The compatible unit 600 does not include a discharge portion that directly dispenses purified water to a user as in the faucet part 400, and includes a connection unit 601 formed upward. In this case, a position of the connection unit 601 may be variously changed and is not necessarily limited to an upper direction, and instead, the connection unit 601 may also be formed in a lateral direction of the compatible unit 600.

Although not shown, a separate external pipe may be connected to the connection unit 601, and the separate pipe may extend to a discharge portion at which purified water is finally dispensed. Accordingly, the water purifier 11 in FIG. 10B, in which the compatible unit 600 is mounted, may be used as a so-called built-in water purifier. That is, the water purifier 11 of FIG. 10B may be installed inside a sink or basin, and a separate pipe connected to the connection unit 601 may be connected to a discharge portion exposed to the outside of the sink or basin to provide purified water through the discharge portion.

Accordingly, the water purifier according to the present example embodiment may be selectively used as a tabletop water purifier 10 as in FIG. 1A or as a built-in water purifier 11 as in FIG. 10B through selective mounting of the faucet part 400 and the fixing unit 300 or the compatible unit 600.

Based on the structure of the water purifier 10 illustrated in FIG. 1A, and with additional reference to FIG. 10A to FIG. 10C, a method for performing compatibility of the water purifier 10, that is, a method of compatibly mounting the faucet part 400 and the fixing unit 300 and the compatible unit 600 on the water purifier 10, will be described.

First, when the water purifier 10 is used as a tabletop water purifier as in FIG. 1A, a user may dispense purified water through the discharge portion 430 positioned on the second surface 120.

Subsequently, in order to convert the tabletop water purifier 10 into a built-in water purifier 11, operations shown in FIG. 1B and FIG. 1C must first be performed. Since these operations have already been explained, duplicate description will be omitted.

Referring to FIG. 10A, as described earlier, when the predetermined clearance space 101 is generated as shown in FIG. 1C, the upper surface 140 of the body part 100 is exposed through the space between the fixing unit 300 and the faucet part 400. In this case, as illustrated, a coupling frame 190 and a coupling portion 195 are exposed to the outside through the clearance space 101.

The coupling frame 190 is a frame structure extending in the second direction Y and fixing the faucet part 400 and the fixing unit 300, and is coupled to the upper surface 140. That is, a first side of the coupling frame 190 may be coupled to the faucet part 400, and a second side of the coupling frame 190 may be coupled to the fixing unit 300. As shown in FIG. 3, a fastening guide 333 is formed on the sliding surface 312 of the fixing unit 300 so as to be coupled with the coupling frame 190.

As described above, in a state in which the fixing unit 300 and the faucet part 400 are coupled to the coupling frame 190, the coupling frame 190 is fixed to the upper surface 140 of the body part 100 through the coupling portion 195.

Thus, when coupling of the coupling portion 195 exposed to the outside through the clearance space 101 is released, coupling of the fixing unit 300 and the faucet part 400 to the upper surface 140 is also released, and the fixing unit 300 and the faucet part 400 may be removed from the body part 100.

Accordingly, the fixing unit 300 and the faucet part 400 are removed from the body part 100 by releasing coupling of the coupling portion 195.

Thereafter, referring to FIG. 10B, the compatible unit 600 is coupled to the upper surface 140 of the body part 100. Although not shown in detail, a separate coupling unit may be provided on a lower surface of the compatible unit 600 so that the compatible unit 600 may be slid on and fixed to the upper surface 140 of the body part 100, and such coupling method is not particularly limited.

Subsequently, referring to FIG. 10C, in order to fix a position of the compatible unit 600 coupled to the upper surface 140 of the body part 100, the rotation part 210 is returned to the position of FIG. 1A. That is, as indicated by the arrow, the rotation part 210 is rotated again, for example, counterclockwise. Accordingly, although not shown, the rotation bar 230 connected to the rotation part 210 also changes its position and is coupled to a second fixing groove 623 of a second fixing guide 622 formed on the lower surface of the compatible unit 600, as described later.

Thus, the compatible unit 600 is stably fixed to the upper surface 140 of the body part 100 as shown in FIG. 10C. Furthermore, when the compatible unit 600 is coupled as in FIG. 10C, the connection unit 601 may be positioned to face upward, and the water purifier 11 may be used as a so-called built-in water purifier.

Alternatively, by performing the steps described above in reverse order, the compatible unit 600 may be removed from the body part 100, and the faucet part 400 and the fixing unit 300 may be mounted onto the body part 100.

Therefore, whenever necessary, a user may selectively convert between the tabletop water purifier 10 and the built-in water purifier 11 through the simple coupling and releasing operations described above, thereby improving convenience of use.

Meanwhile, a state in which the fixing unit 300 is released prior to coupling of the compatible unit 600 has already been described with reference to FIG. 3. Accordingly, when the compatible unit 600 is coupled, the compatible unit 600 is coupled to the rotation bar 230.

More specifically, referring to FIG. 11, in the compatible unit 600, a second fixing block 620 is formed on a lower surface 612 of a rectangular compatible body 610, and the rotation bar 230 is selectively coupled to the second fixing block 620.

In this case, the first fixing block 320 formed in the fixing unit 300 and the second fixing block 620 formed in the compatible unit 600 have substantially the same structure, and a coupling method using the rotation unit 200 is also the same. That is, the second fixing block 620 also includes a second fixing frame 621 having the same shape as the first fixing frame 321 and a second fixing guide 622 having the same shape as the first fixing guide 322. In addition, the second fixing groove 623 also has the same shape as the first fixing groove 323.

Accordingly, as already described for coupling between the first fixing block 320 and the rotation unit 200, the second fixing block 620 may also be coupled to the rotation unit 200, and duplicate description will be omitted. Likewise, release of coupling between the second fixing block 620 and the rotation unit 200 is also the same and thus will not be redundantly described.

As described above, through relatively simple coupling and releasing, a user may selectively perform conversion between the tabletop water purifier 10 and the built-in water purifier 11.

According to exemplary embodiments of the present invention, the faucet part may be rotated to the first position and the second position, so that the position of the faucet part may be varied in consideration of an installation environment, thereby improving spatial utilization and user convenience. In this case, the faucet part maintains a fixed state by the fixing unit at each of the first position and the second position, which enables more stable fixation.

In contrast, when the fixing unit forms a predetermined clearance space through a simple sliding movement, the faucet part becomes rotatable, and a position variation of the faucet part through rotation may be implemented very easily. In particular, the sliding movement state and the fixed state of the fixing unit according to fixation or release of fixation are implemented through operation of the rotation unit, and may be easily performed by rotating a lever by a user from the exterior. Therefore, a general user who is not a professional may transition the fixing unit between a fixed state and a sliding state simply by operating the rotation part (lever), thereby improving user convenience and operability.

Specifically, the coupling and release may be implemented through coupling and release between a first fixing block formed on a lower surface of the fixing unit and a rotation bar included in the rotation unit, and thus the design and manufacture are simple, the operability is stable and easy, and the system may be manufactured with sufficient durability.

In particular, by guiding position variation of the rotation bar through a guide surface of the support block, coupling and release between the rotation bar and the first fixing block may be performed more stably.

Meanwhile, by guiding sliding of the fixing unit through the guide unit, sliding may be induced only in a predetermined sliding direction and to predetermined sliding positions, so that fixation and release of fixation between the faucet part and the fixing unit may be stably performed. That is, the sliding direction of the fixing unit may be stably guided by the central guide portion of the guide unit and the central protrusion of the fixing unit, and a sliding range of the fixing unit may be stably set through the first and second guide portions of the guide unit and the first and second sliding portions of the fixing unit.

Furthermore, the faucet part is not only guided in a rotation direction through the rotation plate and the fixing plate, but its rotation range is also restricted, so that when rotating the faucet part, the user may rotate it within a limited range in terms of rotation direction and rotation amount, thereby minimizing damage to the faucet part caused by unnecessary rotation.

In addition, since the faucet part and the compatible unit are selectively coupled to the body part, the water purifier may be selectively used as a tabletop type or a built-in type according to a user environment. Thus, suitable installation according to various use environments may enhance usability, convenience, and spatial efficiency.

In addition, since attachment and detachment of the faucet part and the compatible unit may be easily performed through release of a fastening portion, a general user who is not a professional may perform such tasks independently, thereby improving convenience for the user.

In this case, the fixing unit that fixes the position of the faucet part is slid to form a clearance space between the fixing unit and the faucet part, and the fastening portion is released while being exposed outward through the clearance space. Therefore, the fastening portion may be easily released through a simple operation of sliding movement of the fixing unit.

In particular, the state in which the fixing unit is slidable or fixes the faucet part is implemented through operation of the rotation unit, and may be easily performed by rotating the lever by the user from the exterior. Likewise, the compatible unit may also be fixed to the body part by an operation of rotating the same lever.

Therefore, a general user who is not a professional may transition the fixing unit between a fixed state and a sliding state simply by operating the rotation part (lever), and may also transition the compatible unit between a fixed state and a released state, thereby enhancing user convenience and operability.

Specifically, the coupling and release of the fixing unit and the compatible unit may be implemented through coupling and release between a fixing block formed on a lower surface of the fixing unit or the compatible unit, and a rotation bar included in the rotation unit. Thus, the design and manufacture are simple, the operability is stable and easy, and the system may be manufactured with sufficient durability.

Having described exemplary embodiments of the present invention, it is further noted that it is readily apparent to those of reasonable skill in the art that various modifications may be made without departing from the spirit and scope of the invention which is defined by the metes and bounds of the appended claims.

What is claimed is:

1. A water purifier comprising:
a body part;
a fixing unit slidably connected to an upper surface of the body part; and
a faucet part fixed to the upper surface of the body part by the fixing unit, wherein the faucet part rotates from a first position to a second position when a clearance space is formed between the fixing unit and the faucet part as the fixing unit slides.

2. The water purifier of claim 1,
wherein the faucet part comprises a water outlet for discharging purified water and a faucet block in which the water outlet is formed, and
wherein, as the faucet block rotates from the first position to the second position, a position of the water outlet is varied.

3. The water purifier of claim 2,
wherein the faucet block has a rectangular block shape, and
wherein the faucet block is rotated by 90 degrees between the first position and the second position.

4. The water purifier of claim 1, further comprising:
a rotation unit configured to fix or release the fixing unit to or from the upper surface of the body part.

5. The water purifier of claim 4,
wherein the rotation unit comprises:
a rotation bar extending along an upper portion of the body part and configured to be coupled to or decoupled from the fixing unit; and
a rotation part provided at one end of the rotation bar and exposed to an exterior of the body part.

6. The water purifier of claim 5,
wherein the rotation part is operated to rotate, and the rotation bar is thereby coupled to or decoupled from the fixing unit.

7. The water purifier of claim 6,
wherein the body part comprises a support block provided on the upper portion, and
wherein the support block comprises a guide surface configured to guide movement of the rotation bar according to rotation of the rotation part.

8. The water purifier of claim 5,
wherein the fixing unit comprises:
a fixing body having a sliding surface; and
a first fixing block formed on the sliding surface and configured to be coupled to or decoupled from the rotation bar.

9. The water purifier of claim 8,
wherein the first fixing block comprises:
a first fixing frame protruding from the sliding surface; and
a first fixing guide provided inside the first fixing frame and having at least one first fixing groove into which the rotation bar is inserted.

10. The water purifier of claim 1, further comprising:
a guide unit provided in the body part and configured to guide sliding of the fixing unit.

11. The water purifier of claim 10,
wherein the guide unit comprises:
a central guide portion configured to guide the fixing unit; and
first and second guide portions disposed on both sides of the central guide portion and configured to guide a sliding range of the fixing unit.

12. The water purifier of claim 11,
wherein each of the first and second guide portions comprises:
a front guide groove configured to guide the first position during sliding of the fixing unit; and
a rear guide groove spaced apart from the front guide groove by a predetermined distance and configured to guide the second position.

13. The water purifier of claim 12,
wherein the fixing unit is brought into contact with the faucet part at the first position, and
wherein the fixing unit forms the clearance space between the fixing unit and the faucet part at the second position.

14. The water purifier of claim 11,
wherein the fixing unit comprises:
a central protrusion guided along the central guide portion; and
first and second sliding portions disposed on both sides of the central protrusion and configured to move along the first and second guide portions.

15. The water purifier of claim 1,
wherein the faucet part comprises:
a rotation connection portion formed on a rotation surface of a faucet body;
a rotation plate rotatably connected to the rotation connection portion; and
a fixing plate fastened to the rotation connection portion.

16. A water purifier comprising:
a body part;
a faucet part comprising a water outlet from which purified water is discharged and coupled to an upper surface of the body part; and
a connection unit connected to piping through which purified water is supplied, the water purifier further comprising a compatible unit coupled to the upper surface when the faucet part is detached from the upper surface.

17. The water purifier of claim 16,
wherein the water purifier is used as a tabletop type when the faucet part is coupled, and
wherein the water purifier is used as a built-in type when the compatible unit is coupled.

18. The water purifier of claim 17,
wherein the water outlet discharges the purified water downward from the faucet part, and
wherein the connection unit supplies the purified water upward from the compatible unit.

19. The water purifier of claim 16,
further comprising a fixing unit coupled to the upper surface so as to be adjacent to the faucet part,
wherein, when the faucet part is coupled, the fixing unit slides on the upper surface to be in close contact with the faucet part, and
wherein, when coupling of the faucet part is released, the fixing unit slides on the upper surface to form a clearance space between the fixing unit and the faucet part.

20. The water purifier of claim 19,
wherein, when coupling of the faucet part is released, a coupling portion provided in the clearance space is released such that the faucet part and the fixing unit are detached from the body part.
